(19) United States
(12) Patent Application Publication
(10) Pub. No.: US 2008/0030791 A1
(43) Pub. Date: Feb. 7, 2008

(54) Apparatus for Presentation

(76) Inventor: Dong Youn Kang, Busan (KR)

Correspondence Address: HYUN JONG PARK, 41 WHITE BIRCH ROAD, REDDING, CT, 06896-2209, US

(21) Appl. No.: 11/868,940

(22) Filed: Oct. 8, 2007

Related U.S. Application Data
(63) Continuation of application No. PCT/KR06/00952, filed on Mar. 16, 2006.

(30) Foreign Application Priority Data
Apr. 7, 2005 (KR) 10-2005-0029086

(51) Int. Cl. G06F 3/12

(52) U.S. Cl. 358/302; 358/1.15

(57) ABSTRACT

The present invention relates to a presentation apparatus. The presentation apparatus according to the present invention includes a display unit including a first display disposed at one side of the cover, a second display disposed at one side of the main body, and a display controller that controls the first display and the second display, a beam projector unit including a beam projector contained in an installation groove located at either the main body or the cover, and a beam projector controller that controls the beam projector, a microphone unit including a microphone located at either the main body or the cover, and a microphone driver that drives the microphone, a camera unit including a camera located at either the main body or the cover, and a camera driver that drives the camera, and a central processing unit (CPU) that generates a control signal to control each of the constituent elements and transfers the generated control signal to a corresponding constituent element.

### REFERENCE TO RELATED APPLICATIONS

This is a continuation of pending International Patent Application PCT/KR2006/000952 filed on Mar. 16, 2006, which designates the United States and claims priority of Korean Patent Application No. 10-2005-0029086 filed on Apr. 7, 2005.

### FIELD OF THE INVENTION

The present invention relates to a presentation apparatus. In an advanced society, it is common that a business staff directly visits customers for business activities. This trend prevails in the entire industrial fields such as pharmacy, insurance, bank and real estate. In line with this trend, there is a need for discussion on an economic and efficient presentation method.

### BACKGROUND OF THE INVENTION

In general, a business staff may provide customers with documents, such as pamphlets and brochures, in order to present a product or may describe a product using a notebook computer that can output presentation contents. The pamphlets, the brochures and so on, which are provided in document form, are advantageous in that they can attract interest of customers temporarily, but mostly result in waste that come into disuse. Accordingly, a problem arises because an economical cost increases in companies, business staff, customers and the like.

In recent years, in order to overcome the problem, it is common that a business staff describes a product for customers using the notebook computer. In this case, there is also a problem in that the customers' interest is reduced since the booting time of the computer is long.

Furthermore, in the case of presentation employing the notebook computer, a great amount of time is taken to drive applications and a high capacity of memory for a high capacity of applications is required. There are also problems in that the basic specification becomes high and the cost is high.

Furthermore, for efficient presentation, a beam projector must be used, if appropriate. It is, however, inconvenient to prepare the notebook computer and the beam projector separately.

Furthermore, in the case of presentation employing the notebook computer, a problem arises because a business staff must look at the same direction as that of a customer.

Furthermore, when customers respond or make a request, a business staff has to write them into the paper or in a file form one by one.

### SUMMARY OF THE INVENTION

It is an object of the present invention to provide a presentation apparatus further including output means that can output presentation contents to a presentation object.

It is another object of the present invention to provide a presentation apparatus that provides efficient presentation using a beam projector.

It is further another object of the present invention to provide a presentation apparatus that can record and store a presentation process.

It is still another object of the present invention to provide a presentation apparatus that can be mass-produced with a significantly reduced memory capacity.

To achieve the above objects, according to an aspect of the present invention, there is provided a presentation apparatus including a main body and a cover, including a display unit including a first display disposed at one side of the cover, a second display disposed at one side of the main body, and a display controller that controls the first display and the second display, a beam projector unit including a beam projector contained in an installation groove located at either the main body or the cover, and a beam projector controller that controls the beam projector, a microphone unit including a microphone located at either the main body or the cover, and a microphone driver that drives the microphone, a camera unit including a camera located at either the main body or the cover, and a camera driver that drives the camera, and a central processing unit (CPU) that generates a control signal to control each of the constituent elements and transfers the generated control signal to a corresponding constituent element.

In a preferred embodiment, the presentation apparatus may further include a power supply unit including a battery for supplying electric power, and a power converter that controls the electric power corresponding to an element to which the electric power is supplied.

Furthermore, the presentation apparatus may further include an infrared transmission/reception unit including an infrared sensor for receiving a remote controller signal from a wireless remote controller, an infrared LED for transferring a signal to the wireless remote controller, and an infrared transmission/reception controller connected to the infrared sensor and the infrared LED, for controlling the transmission and reception of a signal.

Furthermore, the presentation apparatus may further include a select unit including a keypad, which is located at one side of the main body and has a plurality of select buttons on a function basis, and a key scan circuit corresponding to the keypad.

Furthermore, the presentation apparatus may further include a USB connector and a USB controller for transmitting and receiving data to and from other computing devices.

Furthermore, the presentation apparatus may further include a storage unit including a ROM for storing at least driving system, a RAM which is a temporary storage position of data, an auxiliary storage device for storing applications, and an interface that connects the auxiliary storage device and the CPU.

The auxiliary storage device may be any one of a MMC, a SMC, a flash memory, and a floppy diskette.

The first display may be disposed on a rear surface of the cover and the second display may be disposed on a top surface of the main body.

According to another aspect of the present invention, there is provided a presentation apparatus including a cover having a first display disposed at its one side, a main body having a second display disposed on its top surface, a slide member for allowing the cover to slide the main body, and a rotary member for allowing the cover to rotate about the main body after sliding is completed, wherein the cover and the main body are combined.

In a preferred embodiment, the first display may be disposed on a rear surface of the cover.

The presentation apparatus may further include a beam projector contained in an installation groove formed at either the main body or the cover, and a beam projector controller that controls the beam projector.

Advantageous Effects

According to the present invention, since it is not necessary to provide presentation objects (more particularly, customers) with documents such as pamphlets, the waste of resources can be reduced. Furthermore, according to the present invention, since a presentation apparatus can be designed only for presentation, a booting time can be significantly reduced. In addition, there are advantages such as a rapid speed, a longer lifespan of the battery and a low cost.

Furthermore, according to the present invention, customers' responses can be recorded. Accordingly, there are advantages in that customers' requirements can be known accurately and the recordings can be used as evidence materials for presentation events itself.

Furthermore, according to the present invention, since the beam projector can be built within the presentation apparatus, it can avoid the inconveniences of preparing the beam projector.

### BRIEF DESCRIPTION OF THE DRAWINGS

FIG. 1 is a schematic block diagram showing the inside of a presentation apparatus according to a preferred embodiment of the present invention;

FIG. 2 illustrates a computing environment in which a presenter can be implemented partially or fully according to a preferred embodiment of the present invention;

FIG. 3 is a schematic perspective view showing an external form of the presentation apparatus according to a preferred embodiment of the present invention;

FIG. 4 schematically illustrates the process of opening the presentation apparatus according to a preferred embodiment of the present invention;

FIG. 5 schematically illustrates the relationship between the main body and the cover of the presentation apparatus according to another preferred embodiment of the present invention;

FIG. 6 is a schematic perspective view showing an external form of the presentation apparatus according to a preferred embodiment of the present invention;

FIG. 7 is a partially enlarged perspective view of the presentation apparatus in which a projector is mounted according to another preferred embodiment of the present invention; and

FIG. 8 is a dismantled perspective view of the presentation apparatus according to another preferred embodiment of the present invention.

### DETAILED DESCRIPTION OF THE INVENTION

The present invention will now be described in detail in connection with preferred embodiments with reference to the accompanying drawings.

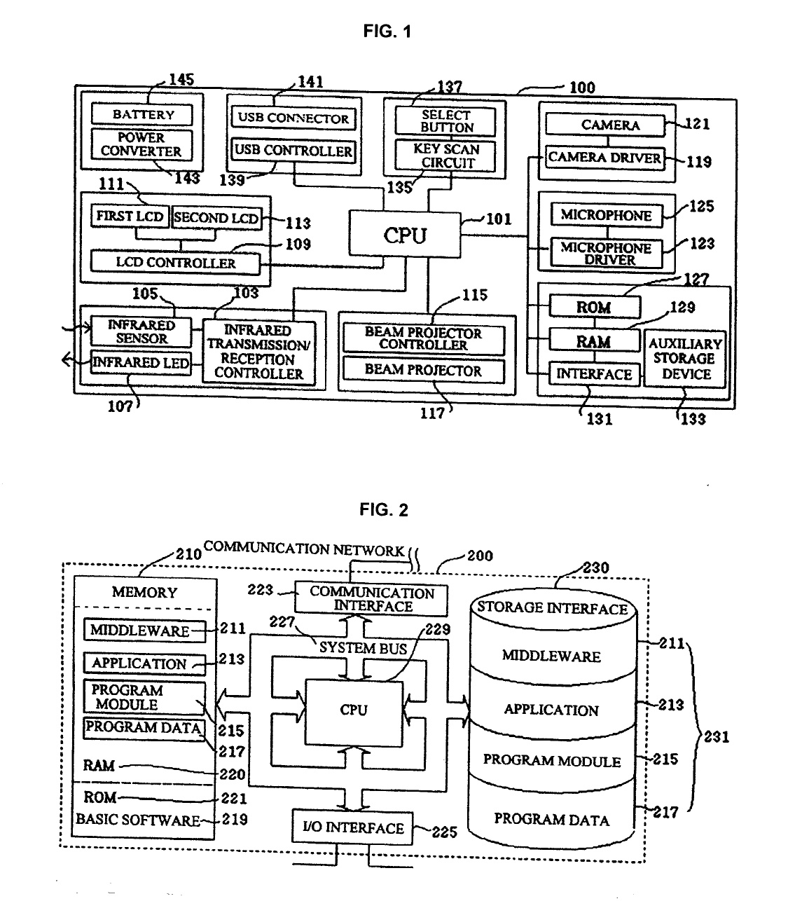

FIG. 1 is a schematic block diagram showing the inside of a presentation apparatus according to a preferred embodiment of the present invention.

Referring to FIG. 1, the presentation apparatus (hereinafter, referred to as a “presenter”) 100 includes a power supply unit, a communication unit, a select unit, a liquid crystal display, an infrared transmission/reception unit, a beam projector unit, a storage unit, a microphone unit, a camera unit, and a central processing unit (CPU) 101. The presenter 100 includes a cover and a main body. Each of the constituent elements will be described below schematically.

The power supply unit includes a battery 145 for supplying electric power necessary to drive the presenter 100, and a power converter 143 for converting predetermined electric power into an electric power value corresponding to each element.

In another preferred embodiment of the present invention, the battery 145 may be replaced with a power connector for introducing external electric power. The power converter 143 converts a control signal of the CPU 101 into an electric power value corresponding to a specific element and supplies electric power. Whether a specific element will be used may be decided according to the control signal.

A variety of interfaces for communications with other computer systems (for example, personal computers) may be used as the communication unit. However, a USB port will be used as the communication unit for convenience of description. The communication unit includes a USB connector 141 for connection to other computer systems, and a USB controller 139.

In the present embodiment, communication with other computer systems can be performed, document files, etc. for presentation can be downloaded from other computer systems, and recorded data of responses of presentation objects (more particularly, customers), which are generated using the presenter, can be uploaded to other computer systems through the USB ports 141, 139.

The select unit includes a plurality of select buttons 137 in which functions have been previously set or several functions for execution can be set, and a key scan circuit 135 for determining which buttons have been pressed.

In another preferred embodiment of the present invention, the select unit may be replaced with a user interface which can be displayed on the liquid crystal display and can be implemented using software. In this case, the liquid crystal display must have a touch screen function. A presentation performer (more particularly, a business staff) may control each constituent element of the presenter or contents to be viewed to a presentation object by using the select unit or a remote controller to be described later.

The liquid crystal display includes a first LCD 111 on which files, etc. for presentation are displayed, a second LCD 113 on which a filed for the presentation or an interface for controlling a display process of a file for the presentation are displayed, and a LCD controller 109 for controlling the first LCD 111 and the second LCD 113.

The first LCD 111 is disposed at the rear of the cover of the presenter 100 so that it orients toward a presentation object. Furthermore, the second LCD 113 is located on a top surface of the main body of the presenter 100 so that it can be seen by a presentation performer.

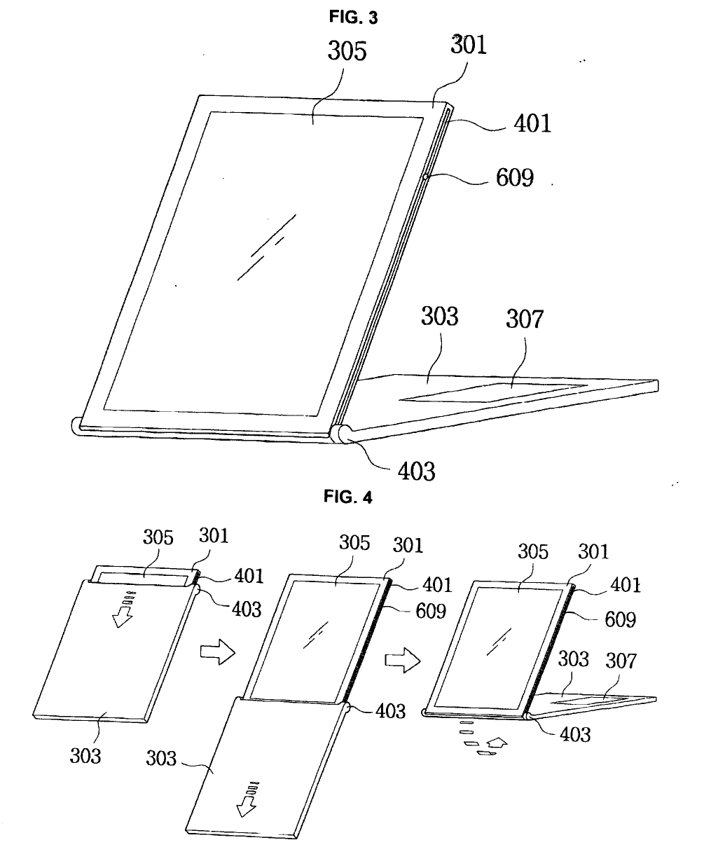

Such positional relations are disclosed in FIGS. 3 to 6. The first LCD 111 and the second LCD 113 may be implemented to output presentation contents. Alternatively, the first LCD 111 may be implemented to output presentation contents and the second LCD 113 may be implemented to output a screen for controlling presentation contents.

The infrared transmission/reception unit includes an infrared sensor 105 for receiving an infrared signal from an external device such as a wireless remote controller, an infrared LED 107 for transmitting the infrared signal to the external device, and an infrared transmission/reception controller 103 responsible for the control of the infrared sensor 105 and the infrared LED 107.

In another preferred embodiment of the present invention, to receive a remote controller signal from a wired remote controller, the infrared transmission/reception unit may be replaced with a wired remote controller signal transmission/reception unit.

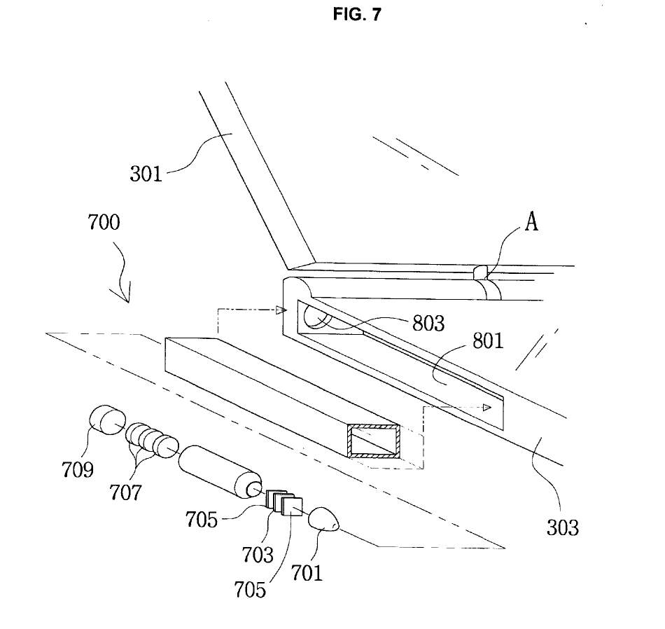

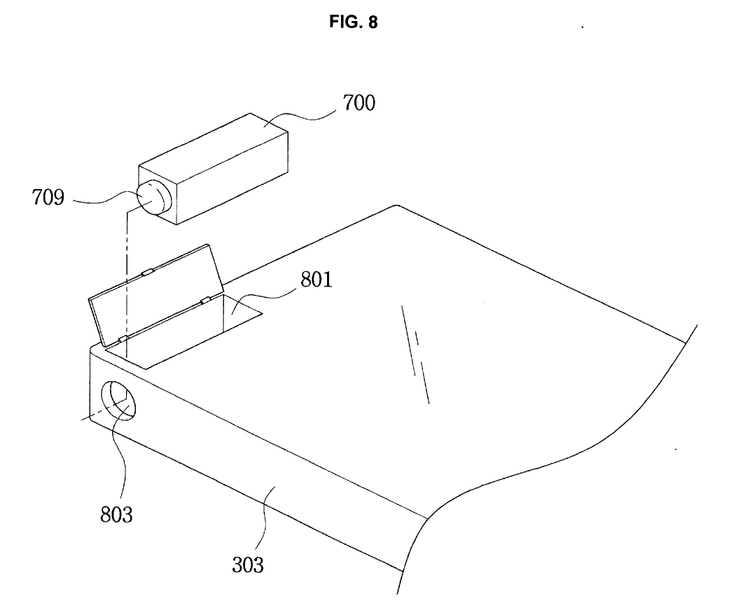

The beam projector unit includes a beam projector 117 for irradiating a beam onto a screen, which is displayed on the first LCD 111 and/or the second LCD 113, and projecting the beam on an external screen (not shown), and a beam projector controller 115 for controlling the beam projector 117. The beam projector unit will be described in detail with reference to FIGS. 7 and 8.

The storage unit includes a ROM 127 for storing a driving system of the presenter 100, etc., a RAM 129 (i.e., a temporary storage position of data, an auxiliary storage device 133 for storing presentation files, etc., and an interface 131 that connects the auxiliary storage device 133 and the CPU 101.

In a preferred embodiment of the present invention, the auxiliary storage device 133 may be a memory card having a large memory capacity and a small size, such as MMC, SMC and flash memory, but may also be a floppy diskette or the like.

The microphone unit includes a microphone 125 that records responses from a presentation object (more particularly, a customer) or records presentation situations of a presentation performer (more particularly, a business staff), and a microphone driver 123 for driving the microphone 125. The camera unit includes a camera 121, and a camera driver 119 for driving the camera 121.

The CPU 101 generates signals for controlling the entire constituent elements of the presenter 100 and transmits the generated signals to control parts of corresponding constituent elements in order to control the constituent elements. In other words, the CPU 101 transmits a control signal for controlling the USB port to the USB controller 139, a control signal for controlling the select unit to the key scan circuit 135, a control signal for controlling the liquid crystal display to the LCD controller 109, a control signal for controlling the infrared transmission/reception unit to the infrared transmission/reception controller 103, a control signal for controlling the beam projector unit to the beam projector controller 115, control signals for controlling the storage unit to the ROM 127, the RAM 129, and the interface 131, respectively, a control signal for controlling the microphone unit to the microphone driver 123, and a control signal for controlling the camera unit to the camera driver 119.

In the embodiment of the present invention, the presenter 100 may include the ROM 127 in which a viewer program for performing only the output for presentation files, such as a word processor, is built. The viewer program has a relatively small capacity in comparison with an application of a large capacity, which is installed at a common computing system. Accordingly, the booting time of the presenter 100 can be significantly reduced, which makes a presentation object's interest continue.

Furthermore, since the viewer program (i.e., an application having a small capacity) is installed, the memory capacity can be significantly reduced and a cheaper presentation apparatus can be provided accordingly. In another embodiment of the present invention, the presenter 100 may include the ROM 127 having a multimedia player function capable of playing multimedia presentation contents.

In the embodiment of the present invention, presentation files, which are recognized by the viewer program, and are stored in the auxiliary storage device 133, etc. or input to the USB port, are output to the first LCD 111 located on a rear surface of the cover of the presenter 100 and/or the second LCD 113 located on a top surface of the main body.

Furthermore, presentation files recognized by the viewer program may be irradiated with a beam by means of the beam projector 117 and then projected on an external screen (not shown). Furthermore, the microphone 125 and the camera 121 may record responses of a presentation object depending on the output of the presentation files or may record presentation situation of a presentation performer. Accordingly, there is an advantage in that a customer's responses or the performance of a business staff are not required to be written one by one. A presentation performer may perform the series of the processes through the infrared transmission/reception unit by controlling the select buttons 137 of the select unit or a remote controller (not shown).

FIG. 2 illustrates a computing environment in which a presenter can be implemented partially or fully according to a preferred embodiment of the present invention.

The computing environment shown in FIG. 2 is an example of the computing system for helping understanding of the present invention and is not intended to limit or restrict the scope of the present invention. The computing environment should not be interpreted as having given dependency or requirements regarding one of the constituent elements in the illustrative computing environment shown in FIG. 2 or a combination thereof.

The computing environment 200 that may be implemented using the presenter may be implemented using constituent elements or environmental factors, of plurality of various general-purpose or special-purpose computing systems. Constituent elements or environmental factors of a computing system that has been generally widely used may include a personal computer, a server computer, several kinds of client—thin clients or thick client, a laptop computer, a handheld PC, a programmable household electronics, a network PC, a mini computer, a main frame, a game console device, a PDA, a mobile terminal, distributed computing environment including the system and the like.

The computing environment 200 includes a general-purpose computing system of a computer form. The constituent elements of the computer may include one or more processing units 229, a system memory 210, and a system bus 227 that connects a variety of system constituent elements including the processing units 229 to the system memory 210. The processing units 229 may process a variety of execution commands, control the computing device and communicate with other electronics and computing devices.

The system bus 227 may include a memory bus or a memory controller, a peripheral bus, and a local bus or a processor bus employing a variety of bus structures and may have several kinds of bus structures.

For example, these structures may include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus.

The computing environment 200 may include various computer-readable media.

The media may be given available media accessible by a computer apparatus, and may include volatile and non-volatile media and removable and non-removable media.

The system memory 210 may include computer-readable media of a volatile memory type, such as a given access memory (RAM) 220, and a non-volatile memory type, such as a read-only memory (ROM) 221.

For example, during a start-up operation, a basic input/output system (BIOS) 219 including basic routines helpful to exchange information among elements within the computing device is stored in the ROM 221. The RAM 220 includes data program modules that can be immediately accessed by the processing units 229 and currently operate.

The computing device may include removable, non-removable, volatile, and nonvolatile computer storage media. The computer storage media may include a hard disk drive for reading data from non-removable and non-volatile magnetic media (not shown) and recording the read data, a magnetic disk drive for reading data from removable and non-volatile magnetic disks (for example, a floppy disk) and recording the read data, and an optical disk drive for reading data from removable and nonvolatile optical disks such as CD-ROM, DVD-ROM and other kinds of optical media and recording the read data.

The hard disk drive, the magnetic disk drive, and the optical disk drive are connected to the system bus 227 by means of one or more data media interfaces 230. Alternatively, the hard disk drive, the magnetic disk drive, and the optical disk drive may be connected to the system bus 227 by means of a SCSI interface.

The disk drives and related computer-readable media provide non-volatile storage positions of computer-readable commands, a data structure, and other data for a program module and the computing device.

It has been shown that the disk drives and related computer-readable media are the hard disk 231, the removable type magnetic disk, and the removable type optical disk. It is, however, to be understood that other types of computer-readable media that can store computer-accessible data, such as magnetic cassettes or other magnetic storage devices, flash memory cards, CD-ROMs, digital versatile disks (DVD) or other optical storage units, RAMs, ROMs, electrically erasable and programmable read-only memories (EEPROM) and so on, may be used to implement the illustrative computing system and environment.

For example, a number of program modules including a middleware 211, one or more application programs 213, other program modules 215, and program data 217 may be stored in the hard disk 231, the magnetic disk, the optical disk, the ROM 221, and the RAM 220. The middleware 211, one or more application programs 213, other program modules 215, and the program data 217 or a combination of them may include program components according to the present invention. The computing device may include a variety of computer-readable media identified by a communication medium.

The communication medium generally implements a computer-readable command, a data structure, a program module or a modulated data signal such as carrier wave or other transmission mechanism, and includes a given information transfer medium.

The term “modulated data signal” refers to a signal which has a characteristic set of one or more signals or has been modified according to a method of encoding information within the signal. For example, the communication medium may include a wired medium, such as a wired network or direct wired connection, and wireless media such as acoustic, RF, infrared rays and other wireless media.

A predetermined combination of the above-mentioned elements may be included within a range of the computer-readable media. A user may input instructions and information to the computing system using an input device and a pointing device, such as a mouse. Other input devices may include a microphone, joystick, game pad, controller, satellite dish, a serial port, a scanner and so on.

These and other input devices may be connected to the processing unit 229 through an I/O interfaces 225 connected to the system bus 227, but may be connected to the processing unit 229 by other interfaces and bus structures, such as a parallel port, a game port and a universal serial bus (USB).

The output device is also connected to the system bus 227 through the I/O interface 225. The computing device may operate in a networked environment employing logical connections of one or more remote computers such as remote computing devices. For example, the remote computing devices may include a personal computer, a portable computer, a server, a router, a network computer, a peer device, other common network node and so on.

It has been described that the remote computing device is a portable computer that may include all or a part of the elements and characteristics described in the present specification regarding the computing device. Logical connections between the computing device and the remote computer may be a local area network (LAN) or a wide area network (WAN).

Such networking environment is common in business offices, an enterprise-wide computer network, Intranet and Internet. In the case where the computing device is implemented in LAN networking environment, it may be connected to the LAN through a network interface or a network adaptor. In the event that the computing device is implemented in WAN networking environment, it may include other means for setting communication through modem or a wide network.

A modem (it may be built in the computing device or external to the computing device) may be connected to the system bus 227 through the I/O interface 225 or other appropriate mechanisms. Under the networked environment as shown in the computing environment 100, the program modules described regarding the computing device or parts of the program modules may be stored in the remote memory device.

FIG. 3 is a schematic perspective view showing an external form of the presentation apparatus according to a preferred embodiment of the present invention.

Referring to FIG. 3, the presenter 100 includes a cover 301 and a main body 303. A first LCD 305 is located at the rear of the cover 301. A second LCD 307 is located on a top surface of the main body 303.

The first LCD 305 outputs presentation files to be viewed to a presentation object. Furthermore, the second LCD 307 outputs presentation files to be viewed to a presentation performer or an interface capable of controlling the process of outputting presentation files in the first LCD 305.

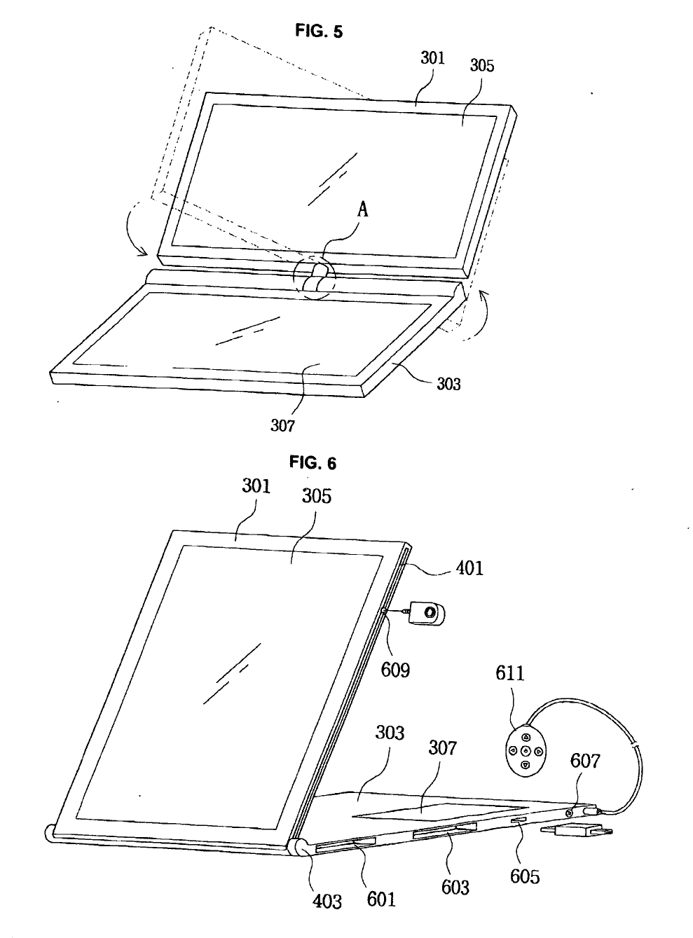

On the top surface of the main body 303 may be located a plurality of select buttons, which are selected to perform a specific function by a presentation performer, other than the second LCD 307. The positional relationship between the first LCD 305 and the second LCD 307 of the presenter 100 will be described in more detail with reference to FIGS. 4 and 5.

FIG. 4 schematically illustrates the process of opening the presentation apparatus according to a preferred embodiment of the present invention.

Referring to FIG. 4, if the main body 303 is pushed in an arrow direction or the cover 301 is pushed in a direction opposite to the arrow direction in order to open the presenter, the main body 303 slides in the arrow direction and/or the cover 301 slides in the direction opposite to the arrow direction by means of a slide member 401 located between the main body 303 and the cover 301. If the main body 303 is rotated about the cover 301 after the sliding, the main body 303 is rotated by the rotary member 403, resulting in having the shape as shown in FIG. 3.

In another preferred embodiment of the present invention, when the slide member 401 operates, i.e., when the cover is opened or shut, electric power of the presenter may be turned on or off. In more detail, the power switch of the presenter may be triggered depending on whether the slide member 401 operates. Detailed shapes of the slide member 401 and the rotary member 403, which can be easily implemented by those skilled in the art belonging to the present invention, are not written in the present specification.

FIG. 5 schematically illustrates the relationship between the main body and the cover of the presentation apparatus according to another preferred embodiment of the present invention.

Referring to FIG. 5, the cover 301 and the main body 303 of the presenter are combined by a rotary member A. If the rotary member A rotates, the first LCD 305 located on one side of the cover 301 can be located in a direction of a presentation object.

FIG. 6 is a schematic perspective view showing an external form of the presentation apparatus according to a preferred embodiment of the present invention.

Referring to FIG. 6, the presenter includes the cover 301 and the main body 303. The first LCD 305 is disposed on the rear surface of the cover 301. The second LCD 307 is disposed on the top surface of the main body 303. Furthermore, a camera connector 609 to which a camera can be connected is located on one side of the cover 301.

A battery charging supply unit 607 for charging the battery, a USB connector 605, an auxiliary storage device inlet port 603 to which an auxiliary storage device, such as a floppy diskette, can lead, a beam projector inlet port 601 to which a beam projector can lead, and so on may be disposed on one side of the main body 303.

Furthermore, an infrared transmission/reception unit (not shown) for receiving an infrared signal from a remote controller 611 may be disposed on the other side of the main body 303. A keypad (i.e., a combination of a plurality of select buttons which allow a presentation performer to select a specific function) may be disposed on the top surface of the main body 303.

FIG. 7 is a partially enlarged perspective view of the presentation apparatus in which a projector is mounted according to another preferred embodiment of the present invention. FIG. 8 is a dismantled perspective view of the presentation apparatus according to another preferred embodiment of the present invention.

Referring to FIG. 7, a projector 700 is mounted in an installation groove 801 within the main body 303 of the presenter. The projector 700 irradiates contents, which are output to the first LCD (not shown) disposed on the rear surface of the cover 301 of the presenter and/or the second LCD (not shown) disposed on the top surface of the main body 303, with a beam and projects the irradiated contents on the external screen (not shown). The projector 700 may be installed detachably within the installation groove 801 of the main body 303 as one assembly or may be disposed on a component basis.

The projector 700 includes a light source 701 that irradiates an optical beam, a liquid crystal display plate 703 that selectively transmits light incident from the light source 701, and a projection lens 707 which changes the path of light that has passed through the liquid crystal display plate 703, enlarges the light so that it is focused on the screen, and projects the enlarged light.

The light source 701 includes a lamp that generates light such as metal halide and xenon, and a reflection mirror which reflects light irradiated from the lamp and guides a progress path. The light irradiated from the lamp is reflected from the reflection mirror and is then projected on the liquid crystal display plate 703.

The liquid crystal display plate 703 is image forming means and has polarization plates 705 at its front and rear sides. The liquid crystal display plate 703 generates an image through the medium of incident light. The projection lens 707 includes a plurality of lens units. The projection lens 707 decides a focal degree and a magnification ratio of an image projected on the liquid crystal display plate 703, enlarges the image and projects the enlarged image on the screen.

In the case where the projector 700 is mounted in the installation groove 801 of the main body 303 of the presenter, a lens 709 located at the end of the projection lens 707, for finally projecting light on the screen is disposed to project through an opening 803 formed at one side of the main body 303 corresponding to the lens 709. The lens 709 may be disposed to rotate up, down, right and left. If the rotation of the lens 709 is unnecessary, a locking unit for fixing the lens 709 at its regular position may be further provided.

A driving circuit of the projector 700 is integrally built in a main circuit substrate (not shown) within the presenter. The driving circuit may include a presenter, and a mode select function capable of selecting an operation mode for operating the projector 700 separately or simultaneously.

Therefore, in the event that presentation contents are to be output only to the first LCD and/or the second LCD using the presenter, the supply of electric power to the projector 700 may be stopped. In the event that presentation contents are not to be output to the first LCD and/or the second LCD using the presenter, electric power may be supplied to the projector 700.

The present invention is not restricted by the embodiments. It is to be appreciated that those skilled in the art can modify the embodiments in various ways without departing from the scope and spirit of the present invention.

### INDUSTRIAL APPLICABILITY

The presentation apparatus of the present invention is advantageous in that it can perform more efficient presentation using a dual LCD, can record customers' responses instantly, and can perform presentation more rapidly at a time desired by a customer, from the viewpoint of a business staff.

Furthermore, the presentation apparatus of the present invention is advantageous in that it can save waste of documents such as pamphlets, can perform presentation suitable for a company's policy, can easily know customers' requirements through recording, can easily know the capability of performing presentation of a business staff, can supply a presentation apparatus cheaper than an existing notebook computer, and can save the cost since pamphlets, brochure and so on can be fabricated, updated or modified without additional printing, from the viewpoint of enterprises.

What is claimed is:

1. A presentation apparatus including a main body and a cover, the apparatus comprising:
a display unit including a first display disposed at one side of the cover, a second display disposed at one side of the main body, and a display controller that controls the first display and the second display;
a beam projector unit including a beam projector contained in an installation groove located at either the main body or the cover, and a beam projector controller that controls the beam projector;
a microphone unit including a microphone located at either the main body or the cover, and a microphone driver that drives the microphone;
a camera unit including a camera located at either the main body or the cover, and a camera driver that drives the camera; and
a central processing unit (CPU) that generates a control signal to control each of the constituent elements and transfers the generated control signal to a corresponding constituent element.

2. The presentation apparatus as claimed in claim 1, further comprising a power supply unit including a battery for supplying electric power, and a power converter that controls the electric power corresponding to an element to which the electric power is supplied.

3. The presentation apparatus as claimed in claim 1, further comprising an infrared transmission/reception unit including an infrared sensor for receiving a remote controller signal from a wireless remote controller, an infrared LED for transferring a signal to the wireless remote controller, and an infrared transmission/reception controller connected to the infrared sensor and the infrared LED, for controlling the transmission and reception of a signal.

4. The presentation apparatus as claimed in claim 1, further comprising a select unit including a keypad, which is located at one side of the main body and has a plurality of select buttons on a function basis, and a key scan circuit corresponding to the keypad.

5. The presentation apparatus as claimed in claim 1, further comprising a USB connector and a USB controller for transmitting and receiving data to and from other computing devices.

6. The presentation apparatus as claimed in claim 1, further comprising a storage unit including a ROM for storing at least driving system, a RAM which is a temporary storage position of data, an auxiliary storage device for storing applications, and an interface that connects the auxiliary storage device and the CPU.

7. The presentation apparatus as claimed in claim 6, wherein the auxiliary storage device is any one of a MMC, a SMC, a flash memory, and a floppy diskette.

8. The presentation apparatus as claimed in claim 1, wherein the first display is disposed on a rear surface of the cover and the second display is disposed on a top surface of the main body.

9. A presentation apparatus comprising:
a cover having a first display disposed at its one side;
a main body having a second display disposed on its top surface;
a slide member for allowing the cover to slide the main body; and
a rotary member for allowing the cover to rotate about the main body after sliding is completed, wherein the cover and the main body are combined.

10. The presentation apparatus as claimed in claim 9, wherein the first display is disposed on a rear surface of the cover.

11. The presentation apparatus as claimed in claim 9, further comprising:
a beam projector contained in an installation groove formed at either the main body or the cover; and
a beam projector controller that controls the beam projector.
